(19) United States
(12) Patent Application Publication
(10) Pub. No.: US 2023/0217900 A1
(43) Pub. Date: Jul. 13, 2023

(54) ANIMAL HARNESS

(71) Applicant: Puphazit, LLC, Wynnewood, PA (US)

(72) Inventors: Jamie Lynn Kendall, Wynnewood, PA (US); John Michael Smaltz, Phoenixville, PA (US)

(21) Appl. No.: 18/148,678

(22) Filed: Dec. 30, 2022

Related U.S. Application Data
(60) Provisional application No. 63/297,554, filed on Jan. 7, 2022.

(51) Int. Cl. A01K 27/00

(52) U.S. Cl. CPC A01K 27/002

(57) ABSTRACT

A harness for an animal includes a body portion having first and second sides; an aperture defining an opening extending through the first side of the body portion; a ring positioned in the opening and defining a ring opening; and one or more straps at least partially sandwiched between the first side and the second side of the body portion and configured to secure the body portion to a chest of the animal. A respective strap extends through the aperture and the ring opening. The straps are adapted to move relative to the first side and second side of the body portion in response to an external force on the ring. The movement of the one or more straps relative to the first side and the second side of the body portion in response to an external force tightens the body portion to the animal.

### PRIORITY APPLICATION

This application claims priority to U.S. Prov. App. No. 63/297,554, filed Jan. 7, 2022, which is hereby incorporated by reference in its entirety.

### TECHNICAL FIELD

The present invention generally relates to an animal harness having cinchable straps, and, more particularly, to an animal harness having a body that cinches to an animal when a leash is pulled.

### BACKGROUND

Harnesses are popular alternatives to collars as a means of attaching a leash to an animal (e.g., a dog). Most animal harnesses include straps that secure the harness to the animal. If the harness includes a body portion at all, the straps are typically stitched to the body portion. In addition, the leash attachment is typically fixed with respect to the harness. This results in poor control of the animal when the animal pulls on the leash, because all of the force is applied to one side of the harness.

### SUMMARY

The harnesses described below solve the problem above by providing a leash attachment ring that is coupled to straps that are moveable within the body of the harness. Thus, when the animal pulls, the straps cinch down (substantially uniformly) on the animal and provide more uniform force and better control.

To that end, embodiments of the present disclosure provide a harness for an animal (e.g., a dog). The harness includes a body portion having a first side and a second side. The harness further includes an aperture defining an opening extending through the first side of the body portion. The harness further includes a ring defining a ring opening. The harness further includes one or more straps at least partially sandwiched between the first side and the second side of the body portion and configured to secure the body portion to a chest of the animal. A respective strap of the one or more straps extends through the aperture and extends through the ring opening of the ring. The one or more straps are adapted to move relative to the first side and second side of the body portion in response to an external force on the ring, whereby the movement of the one or more straps relative to the first side and the second side of the body portion in response to an external force tightens the body portion to the chest of the animal.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is an illustration showing a first view of a dog wearing an animal harness, in accordance with some embodiments.

FIG. 2 is an illustration showing a second view of a dog wearing an animal harness, in accordance with some embodiments.

FIG. 3 is an illustration showing a third view of a dog wearing an animal harness, in accordance with some embodiments.

FIG. 4 is an illustration of an animal harness, in accordance with some embodiments.

FIGS. 5A-5B are expanded views of a portion of an animal harness that includes a leash-attachment ring, in accordance with some embodiments.

FIG. 6 is a partial cross-section of an animal harness in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known components have not been described in detail so as not to unnecessarily obscure aspects of the embodiments.

It will also be understood that, although the terms first, second, etc., are, in some instances, used herein to describe various elements, these elements should not be limited by these terms. These terms are used only to distinguish one element from another. For example, a first D-ring could be termed a second D-ring, and, similarly, a second D-ring could be termed a D-ring, without departing from the scope of the various described embodiments. The first D-ring and the second D-ring are both sets of D-rings, but they are not the same D-ring.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

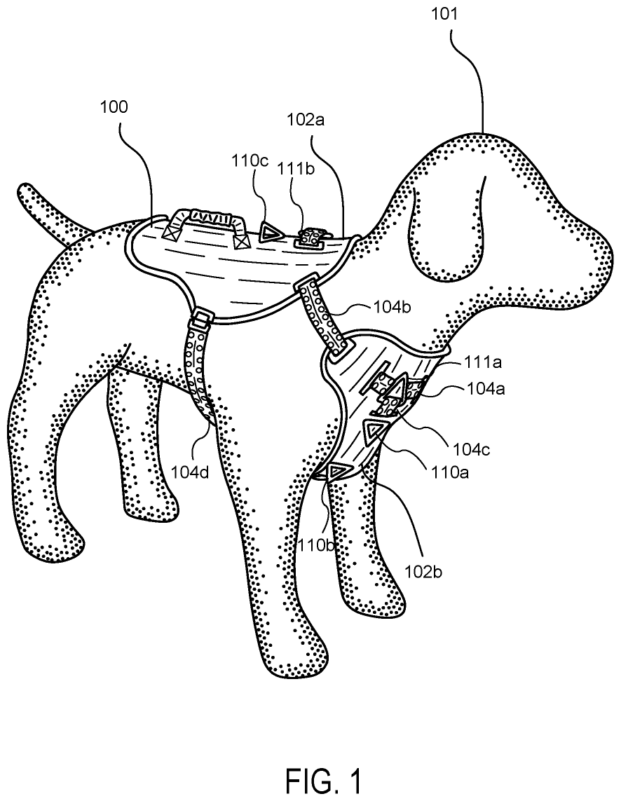

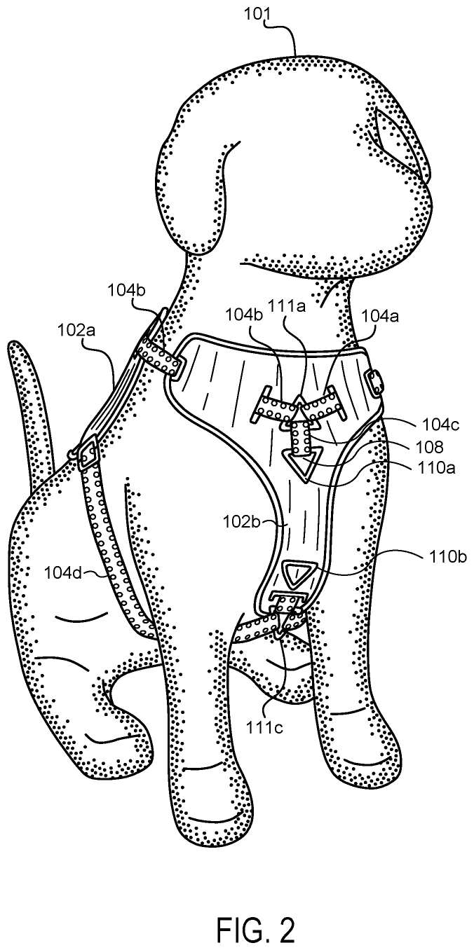

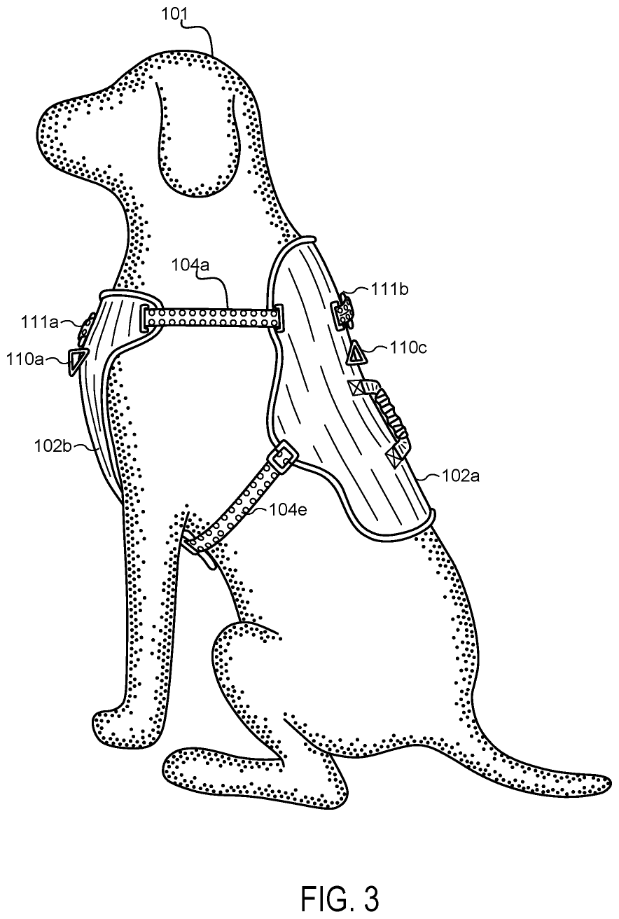

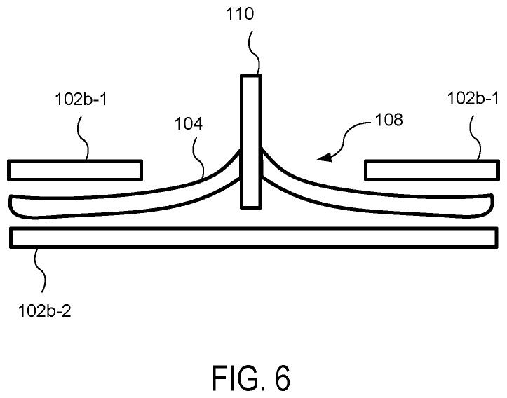

FIGS. 1-3 illustrate various views of a dog 101 wearing an animal harness 100 (e.g., a dog harness), in accordance with some embodiments. The animal harness 100 includes a body portion 102. In the example shown in FIGS. 1-3, the body portion 102 includes a dorsal section 102a and a sternal section 102b. In some embodiments, the body portion 102 is made of a pliable fabric. In this example, the dorsal section 102a and the sternal section 102b are separate sections that are coupled by straps 104 (straps 104a-104f). In some embodiments, however, the body portion 102 is continuous and wraps around the dog 101. The body portion 102 has a first side 102b-1 (FIG. 6) that, in use, faces outwardly from the dog and a second side 102b-2 (FIG. 6) that faces inwardly toward the dog 101 and abuts the dog 101.

The animal harness includes one or more strap connection rings 111 (e.g., strap connection ring 111a and 111b) through which the various straps 104 are mechanically coupled. In some embodiments, the strap connection rings 111 are triangular D-rings.

The animal harness 100 includes one or more leash attachment rings 110. In some embodiments, the animal harness 100 includes a plurality of leash attachment rings 110 (e.g., leash attachment ring 110a around the dog's upper chest; leash attachment ring 110b around the dog's lower chest, and leash attachment ring 110c on the dogs back). In some embodiments, the leash attachment rings 110 are triangular D-rings.

In some embodiments, straps 104 that secure the body portion 102 to the dog 101 are looped through the leash attachment rings 110. Moreover, at least a portion of the straps 104 are movably sandwiched between the first side and the second side of the body portion 102 (e.g., adapted to move relative to the first side and second side of the body portion in response to an external force on the leash attachment ring 110). The result is that, when an external force is applied to a leash attachment ring 110 (e.g., when the leash is pulled), the leash attachment ring 110 pulls on the straps 104 and cinches the straps 104, and thus the body portion 102, to the dog 101. In some embodiments, the strap 104 that passes through the leash attachment ring is coupled with a plurality of other straps 104 (e.g., via the strap connection rings 111). The plurality of straps 104 together circumferentially surround the dog 101. In this manner, when the leash is pulled, the plurality of straps cinch the body portion 102 of the animal harness 100 to the dog in a substantially uniform manner.

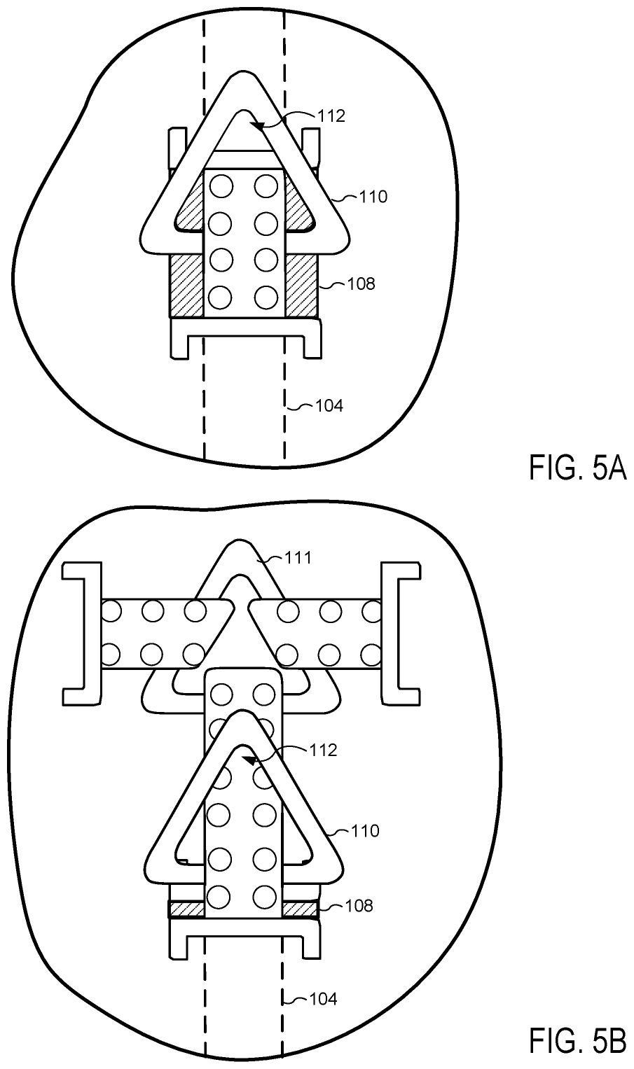

To that end, in some embodiments, as shown in FIGS. 5A-5B and FIG. 6, the animal harness 100 includes an aperture 108 defining an opening extending through (e.g., an opening in) the first side 102b-1 of the body portion 102. In FIG. 6, a first portion of strap 104 is movably sandwiched between the first side 102b-1 and the second side 102b-2 of the body portion 102 of the harness. The strap 104 exits through the aperture 108 and loops through a ring opening 112 of the leash attachment ring 110a. An opposite portion of strap 104 (e.g., opposite the first portion from the leash attachment ring 110a) is also moveably sandwiched between the first side 102b-1 and the second side 102b-2. When a leash attached to leash attachment ring 110a is pulled, the strap 104 slides within the body portion 102 and causes the body portion 102 to cinch to the dog, thus securing the body portion 102 to the chest (and back) of the dog (e.g., the movement of the strap 104 relative to the first side 102b-1 and the second side 102b-2 of the body portion 102 in response to an external force tightens the body portion to the chest of the dog). In some embodiments, the aperture 108 does not extend through the second side 102b-2 of the body portion 102.

It should be noted that FIG. 6 shows one example of a leash attachment ring 110a. However, one of skill in the art having the benefit of this disclosure will understand that any of the leash attachment rings 110 may be embodied in this manner. In addition, in some embodiments, it is not necessary for the strap 104 to be sandwiched between the first side 102b-1 and the second side 102b-2 on both ends of the leash attachment ring 110a. For example, FIG. 5A illustrates an example in which a strap 104 is connected to a strap connection ring 111, remains on the outside of the body portion 102, loops through the leash attachment ring 110, and then enters the body portion 102 (e.g., where it is sandwiched between the two sides) through an aperture 108. In some embodiments, it suffices that a portion of strap 104 is movably sandwiched between two sides of a body portion 102, and a portion of strap 104 is external to body portion 102 and looped through a leash attachment ring 110 so that the leash attachment ring 110 can tug on and move the portion of the strap 104 that is sandwich between the two sides of the body portion 102. Stated another way, although portions of the straps 104 are internal to the body portion 102, the straps 104 are configured to communicate with a leash by means of external portions of the straps that are looped through the leash attachment rings 110.

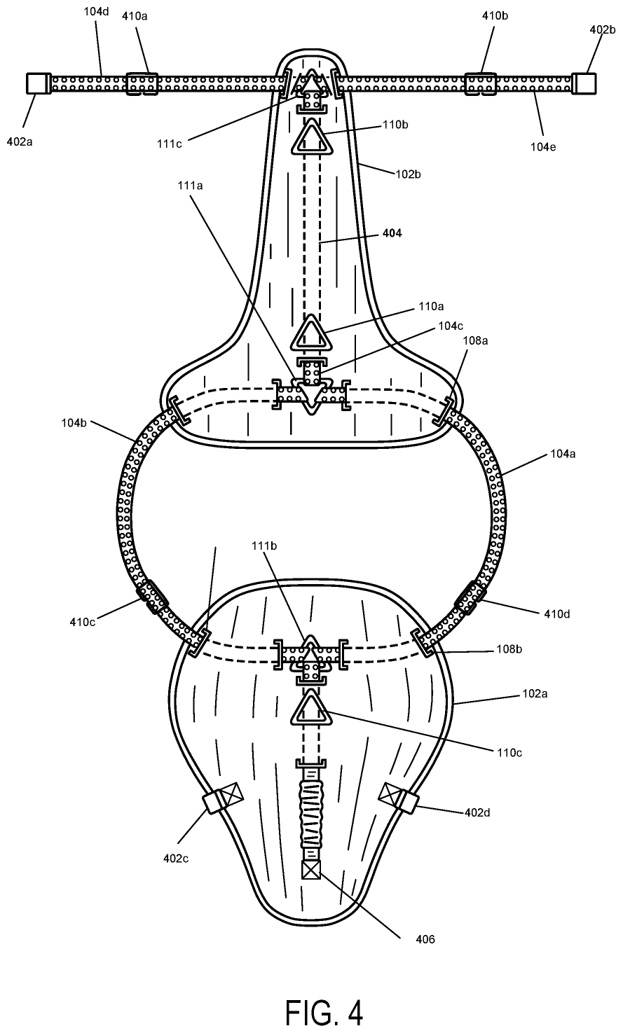

FIG. 4 is an illustration of animal harness 100, in accordance with some embodiments. For brevity, features of animal harness 100 discussed with respect to other figures are not repeated here.

Animal harness 100 includes a plurality of straps 104 (e.g., straps 104d and 104e) that form an abdominal loop for the animal. For example, the abdominal loop comprises a pair of straps adapted to circumferentially circle the animal's waist. In some embodiments, the pair of straps are not stitched to the body portion of the harness. The plurality of straps 104 that form the abdominal loop for the animal are coupled within the sternal section 102b of the body portion 102 of the animal harness 100 via strap connecting ring 111c. The size of the abdominal loop is adjustable via adjustors 410a and 410b. In some embodiments, the plurality of straps 104 that form the abdominal loop terminate with connectors 402 that connect to the dorsal section 102a of the body portion 102 of the animal harness. For example, strap 104d terminates with connector 402a, which couples with connector 402c on the dorsal section 102a, and strap 104e terminates with connector 402b, which couples with connector 402d on dorsal section 102a. In some embodiments, the connectors 402 are magnetic connectors.

In FIG. 4, the dashed lines 404 show where the straps 104 are moveably sandwiched between, and thus internal to, the body portion 102. The straps pass in and out of the body portion 102 via apertures 108 (only a few of which, e.g., such as aperture 108a and aperture 108b, are labeled for visual clarity).

Animal harness 100 includes a plurality of straps 104 that form a neck loop for the animal (e.g., straps 104a and 104b). For example, the neck loop comprises a pair of straps adapted to circumferentially circle the animal's shoulders and/or neck. In some embodiments, the pair of straps are not stitched to the body portion of the harness. The size of the neck loop is adjustable via adjustors 410c and 410d. In some embodiments, portions of the straps 104 that form the next loop for the animal are internal to both the dorsal section 102a and the sternal section 102b of the body portion 102. Straps 104a and 104b are coupled within dorsal section 102a at a first end by strap connection ring 111b and are coupled within the sternal section 102b at a second end opposite the first end by strap connecting ring 111a.

The neck loop, formed by straps 104a and 104b, is coupled to the abdominal loop, formed by straps 104d and 104e, by strap 104c. To that end, a first end of strap 104c is coupled to strap connecting ring 111a and a second end of strap 104c is coupled to strap connecting ring 111b.

The neck loop, formed by straps 104a and 104b, is also coupled to a stitched anchor point 406.

In some embodiments, each respective leash attachment ring 110 has a respective strap 104 that exits the body portion 102 and loops through the ring opening of the attachment ring (as shown in the various embodiments depicted in FIGS. 5A-5B and FIG. 6). Thus, as can be seen above, a leash pull on any of the leash attachment rings 110 causes at least some tightening of all of the straps 104 via direct transfer of tension in the straps, causing a circumferential and at least somewhat uniform cinching of the animal harness 100 to the animal (note that typically only one of the leash attachment rings 110 is attached to a leash at any given time, as it is the choice of the handler). In this manner, the pair of straps forming the abdominal loop and the pair of straps forming the neck loop are movably coupled to one another. The circumferential cinching of the animal harness 100, and in particular the cinching of the body portion 102 of the animal harness 100, exerts better control of the animal, and is more comfortable for and comforting to the animal than conventional methods of controlling the animal (such as a head halter or a choke collar).

FIGS. 5A-5B show various arrangements of the straps 104, the body portion 102, and the leash connecting rings 110. For example, in FIG. 5A, aperture 108 defines an opening in one side of the body portion 102 (e.g., the outwardly facing side), and the leash connecting ring is positioned within the opening. The strap 104 is sandwiched between the first side and the second side of the body portion 102 (as shown in FIG. 6) on both sides of the leash attachment ring 110. The strap passes through the ring opening 112 defined by the leash attachment ring 110. In FIG. 5B, the strap 104 is coupled to a strap connecting ring 111 on one side of the leash attachment ring 110 and remains external to the body portion 102 on that side of the leash attachment ring 110. The strap 104 passes through the ring opening 112 defined by the leash attachment ring 110 and then enters the body portion 102 (where it is moveably sandwiched between the two sides) through an aperture 108 on the opposite side of the leash attachment ring 110.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated

What is claimed is:

1. A harness for an animal, comprising:
a body portion having a first side and a second side;
an aperture defining an opening extending through the first side of the body portion;
a ring defining a ring opening; and
one or more straps at least partially sandwiched between the first side and the second side of the body portion and configured to secure the body portion to a chest of the animal, wherein:
a respective strap of the one or more straps extends through the aperture and extends through the ring opening of the ring, and
the one or more straps are adapted to move relative to the first side and second side of the body portion in response to an external force on the ring, whereby the movement of the one or more straps relative to the first side and the second side of the body portion in response to an external force tightens the body portion to the chest of the animal.

2. The harness of claim 1, wherein the one or more straps include at least three straps that are coupled at the body portion.

3. The harness of claim 1, wherein the one or more straps include a first pair of straps adapted to circumferentially circle the animal's shoulders.

4. The harness of claim 3, wherein the first pair of straps are not stitched to the body portion of the harness.

5. The harness of claim 3, wherein the one or more straps include a second pair of straps adapted to circumferentially circle the animal's waist.

6. The harness of claim 5, wherein the first pair of straps is movably coupled to the second pair of straps via a first respective strap that is not part of the first pair of straps or the second pair of straps.

7. The harness of claim 5, wherein the first pair of straps is coupled to an anchor point.
